(19) United States
(12) Patent Application Publication
(10) Pub. No.: US 2023/0312844 A1
(43) Pub. Date: Oct. 5, 2023

(54) Plant-Based Fibrous Product For Thermoforming

(71) Applicant: Mativ Holdings, Inc., Alpharetta, GA (US)

(72) Inventors: Vincent Motin, Clohars-Carnoet (FR); Arthur Gouth, Le Mans (FR); Thomas McKay, Prosperity, SC (US)

(21) Appl. No.: 18/192,138

(22) Filed: Mar. 29, 2023

Related U.S. Application Data
(60) Provisional application No. 63/324,894, filed on Mar. 29, 2022.

(51) Int. Cl. C08J 5/04

(52) U.S. Cl. CPC C08J 5/045; C08J 2300/22

(57) ABSTRACT

A fibrous product for use in a variety of applications. The fibrous product particularly well suited for use in thermoforming 3-D articles such as food packaging, automotive parts, and electronic packaging. The fibrous product can be biodegradable, recyclable, and compostable. The fibrous product can contain a first plant fiber that is a non-wood fiber.

### RELATED APPLICATIONS

The present application is based upon and claims priority to U.S. Provisional Patent Application Ser. No. 63/324,894, having a filing date of Mar. 29, 2022, and which is incorporated herein by reference.

### BACKGROUND

Cellulose fibers and materials have been used extensively as packaging materials since the late 18^{th} century, only beginning to be meaningfully replaced in the latter part of the 20^{th} century largely by high performance plastics. In modern times, the environmental impact of these high performance plastics has raised concerns among consumers. Notably, these high performance plastics are generally much more difficult to valorize in recycling processes and are generally not readily biodegradable. This environmental incompatibility has resulted in higher public demand for environmentally compatible alternatives.

The higher demand for environmentally compatible packaging alternatives, in addition to increased company focus on corporate sustainability initiatives, has led to many industries returning to cellulose-based packaging options. As a result of the wide availability of wood-derived cellulose fiber, many industries have employed wood-based fiber in their packaging materials. However, the use of wood-based fiber can present a variety of environmental concerns.

In the present-day, research is limited on the applicability of non-wood, plant-based fiber sources for applications involving thermoforming. Indeed, both the source of fiber and the mechanical properties of the fibrous product derived from said fiber source vary greatly. Further, research is limited on the applicability of utilizing pre-existing fiber sources for constructing packaging materials. Notably, the utilization of a pre-existing fiber source can be substantially beneficial to the environment. The environmental burden of growing the pre-existing fiber source would not be increased as the fiber is already being grown for a different purpose, such as the oil or fruit of the pre-existing fiber source.

Thus, in view of the above, a need currently exists for a fiber composition that is formed from non-wood, plant-based fiber and that possesses enhanced physical and mechanical properties.

### SUMMARY

In general, the present disclosure is directed to a fibrous product for forming thermoformed articles. The fibrous product can comprise a plant-based fibrous composition. In one aspect, the plant-based fibrous composition can comprise a first plant fiber. For instance, the first plant fiber can be a non-wood fiber. In one aspect, the first plant fiber can have an average fiber length less than about 0.75 mm. The plant-based fibrous composition can also comprise a binder. For instance, the binder can be a natural polymer. The binder can be present in the plant-based fibrous composition in an amount less than that about 3% by weight.

In one aspect, the first plant fiber can comprise secondary plant fibers. For instance, the first plant fiber can comprise canola fibers. Further, in yet another aspect, the first plant fiber can be derived from chemically refined stalk.

Additionally, in one aspect, the plant-based fibrous composition can have a basis weight from about 50 gsm to about 1000 gsm, such as from about 400 gsm to about 700 gsm. In another aspect, the plant-based fibrous composition can have a tear index from about 3 mN m²/g to about 6 mN m²/g. Furthermore, in yet another aspect, the plant-based fibrous composition can have a freeness from about 250 mICSF to about 750 mICSF.

The plant-based fibrous composition of the present disclosure can have a tensile index from about 10 N m/g to about 60 N m/g. Additionally, the plant-based fibrous composition can have a burst index from about 0.3 kPa m²/g to about 3.3 kPa m²/g. In one aspect, the plant-based fibrous composition can have a tensile energy absorption from about 2 J/m² to about 60 J/m². In another aspect, the plant-based fibrous composition can have a bulk from about 1.5 cm³/g to about 3.5 cm³/g. The first plant fiber can also, in one aspect, have a diameter from about 5 μm to about 50 μm.

In one aspect, the plant-based fibrous composition can further comprise a second plant fiber. In one aspect, the second plant fiber can comprise flax fiber, hemp fiber, kenaf fiber, ramie fiber, jute fiber, or a combination thereof.

Further, in one aspect, the first plant fiber can have an average fiber length that is shorter than average fiber length of the second plant fiber.

As indicated previously, the plant-based fibrous composition of the present disclosure can comprise a natural polymer. In one aspect, the natural polymer can comprise any one of a starch, a starch derivative, a cellulose derivative, alginate, guar gum, a polysaccharide, lignin, natural rubber, polylactic acid, or mixtures thereof.

The fibrous product of the present disclosure can be a 3-dimensional product.

The present disclosure is also directed to a process for producing a fibrous product. The process can comprise introducing a first plant fiber in a tank containing a liquid medium. The liquid medium can comprise sodium hydroxide. The process can also include cooking the first plant fiber. The cooking of the first plant fiber can occur under atmospheric conditions. Additionally, the process can include a first washing of the first plant fiber. The first washing can increase the solids content of the first plant fiber to a range from about 15% to about 45%. Further, the process can include refining the first plant fiber, can include screening the first plant fiber, and can include a second washing of the first plant fiber.

In one aspect, the first plant fiber of the above process can be a non-wood fiber. For instance, the non-wood fiber can be canola fiber.

Further, in one aspect, the second washing of the first plant fiber can increase the freeness of the first plant fiber by about 150% to about 400% when compared to the freeness of the first plant fiber after the screening of the first plant fiber.

### BRIEF DESCRIPTION OF THE DRAWINGS

A full and enabling disclosure of the present disclosure is set forth more particularly in the remainder of the specification, including reference to the accompanying figures, in which:

FIG. 1 is a graph of the Tear Index vs. Freeness in accordance with the Example below;

FIG. 2 is a graph of the Tensile Index vs. Freeness in accordance with the Example below;

FIG. 3 is a graph of the Burst Index vs. Freeness in accordance with the Example below;

FIG. 4 is a graph of the TEA vs. Freeness in accordance with the Example below;

FIG. 5 is a graph of the Bulk vs. Freeness in accordance with the Example below;

FIG. 6 is a perspective view of one embodiment of food packaging made in accordance with the present disclosure.

Repeat use of reference characters in the present specification and drawings is intended to represent the same or analogous features or elements of the present disclosure.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a fibrous product that can be used in various different applications. For example, in one aspect, the fibrous product can be used to thermoform a variety of thermoformed articles such as food packaging, automotive parts, or electronics packaging. In one aspect, the fibrous product can comprise a plant-based fibrous composition. The plant-based fibrous composition, for instance, can comprise a first plant fiber. The first plant fiber, for instance, can be derived from a non-wood fiber source. The present inventors have discovered that the utilization of fibers exhibiting particular physical and mechanical properties can result in the plant-based fibrous composition as disclosed possessing enhanced physical and mechanical properties such as tear index, freeness, tensile index, burst index, tensile energy absorption, and bulk. Indeed, the present inventors have discovered that selectively choosing the plant of which the fibers are derived, the mechanical and physical properties of the fibers, and the means by which the fibers are processed can result in a fibrous product possessing improved physical and mechanical properties.

The fibrous product of the present disclosure can have enhanced biodegradability. Indeed, the fibrous product disclosed herein can be, in one aspect, 100% biodegradable. In one aspect, the fibrous product can be 100% compostable such that the fibrous product can decompose into natural elements. Further, in one aspect, the fibrous product can be 100% recyclable, such that the fibrous product can be formed into raw material for use in producing other products.

In one aspect, the plant-based fibrous composition can comprise a first plant fiber. For instance, the first plant fiber can be a non-wood fiber. The non-wood fiber can be derived from canola, sugar beat, flax, hemp, wheat, lavender, malt grain, miscanthus, silphia, cocoa shells, bamboo, Lyocell, or a combination thereof.

As disclosed herein, in one aspect, the first plant fiber can comprise canola fibers. Canola, or the canola plant, can refer to cultivars bred to have low levels of erucic acid, a monounsaturated fatty acid. Notably, the erucic acid content of the canola plant seed is generally less than about 2% by weight of the total fatty acid content of the canola plant seed. Generally, canola is cultivated for its oil-rich seeds. By selectively optimizing the levels of erucic acid through breeding, canola has become one of the largest sources of oil and protein in the world. The seeds of the canola plant are harvested for their vegetable oil, also referred to as canola oil. However, the remaining parts of the canola plant, such as the stalk, have historically been considered as waste or as a byproduct of canola oil production. As used herein, the term “stalk” is used to refer to the main structural portion of a plant that remains after the leaves have been removed.

In one aspect, the first plant fiber is derived from canola stalk that is mechanically refined. In another aspect, the first plant fiber is derived from canola stalk that is chemically refined. In yet another aspect, the first plant fiber is derived from canola stalk that is both mechanically and chemically refined.

As used herein, the term “refine” is used to mean that the plant material is subjected to a mechanical or chemical treatment that modifies the fibers of the material so that they are better suited to forming a fibrous sheet or substrate. For example, refining can separate/individualize the fibers and fibrillate the fibers, which promotes hydrogen bonding between fibers and/or fibrils and increases the web strength. Refining can be accomplished, for instance, using a conical refiner, disks refiner, or a beater such as a Valley beater. The mechanical process exerts an abrasive and bruising action on the plant material such that the plant material is deformed and declustered. Refining can also be accomplished, for instance, using a hydrapulper containing a liquid medium.

In one aspect, the first plant fiber can comprise secondary plant fibers. Generally, secondary plants are plants that are not specifically grown for their fiber but are instead grown for a different purpose, such as for their fruit or oil. The secondary plant fibers can be considered to be a byproduct of secondary plant harvesting. The secondary plant fibers, for instance, can be derived from at least one secondary plant such as oil palm, agave, and/or canola. The secondary plant fibers derived from the aforementioned secondary plants can be oil palm fibers, agave fibers, and/or canola fibers respectively.

As used herein, the average fiber length is measured according to TAPPI T271. The first plant fiber, in one aspect, can have an average fiber length from about 0.25 mm to about 1.0 mm, such as greater than about 0.25 mm, such as greater than about 0.35 mm, such as greater than about 0.45 mm, such as greater than about 0.55 mm, such as greater than about 0.65 mm, such as greater than about 0.75 mm, such as greater than about 0.85 mm, such as greater than about 0.95 mm. In general, the first plant fiber has a fiber length less than about 1.0 mm, such as less than about 0.95 mm, such as less than about 0.85 mm, such as less than about 0.75 mm, such as less than about 0.65 mm, such as less than about 0.55 mm, such as less than about 0.45 mm, such as less than about 0.35 mm.

In one aspect, the first plant fiber can have an average fiber diameter from about 5 μm to about 600 μm, such as greater than about 5 μm, such as greater than about 7 μm, such as greater than about 9 μm, such as greater than about 11 μm, such as greater than about 13 μm, such as greater than about 15 μm, such as greater than about 17 μm, such as greater than about 19 μm, such as greater than about 21 μm, such as greater than about 25 μm, such as greater than about 30 μm, such as greater than about 40 μm, such as greater than about 50 μm, such as greater than about 100 μm, such as greater than about 200 μm, such as greater than about 300 μm, such as greater than about 400 μm, such as greater than about 500 μm. Generally, the first plant fiber has an average fiber diameter less than about 600 μm, such as less than about 500 μm, such as less than about 400 μm, such as less than about 300 μm, such as less than about 200 μm, such as less than about 100 μm, such as less than about 50 μm, such as less than about 40 μm, such as less than about 30 μm, such as less than about 25 μm, such as less than about 21 μm, such as less than about 19 μm, such as less than about 17 μm, such as less than about 15 μm, such as less than about 13 μm, such as less than about 11 μm, such as less than about 9 μm, such as less than about 7 μm. Notably, the fiber diameter can affect the bulk of the plant-based fibrous composition.

Generally, the first plant fiber can be derived from the stalk of the plant from which the first plant fiber is derived. The stalk can contain both bast fiber and pith cells. For instance, the amount of bast fiber in the stalk can be from about 3% to about 15% by weight, such as from about 3% to about 5% by weight, such as from about 5% to about 7% by weight, such as from about 7% to about 9% by weight, such as from about 9% to about 11% by weight, such as from about 11% to about 13% by weight, such as from about 13% to about 15% by weight. Additionally, for instance, the amount of pith cells in the stalk can be from about 1% to about 15% by weight, such as from about 3% to about 5% by weight, such as from about 5% to about 7% by weight, such as from about 7% to about 9% by weight, such as from about 9% to about 11% by weight, such as from about 11% to about 13% by weight, such as from about 13% to about 15% by weight. In one aspect, the stalk from which the first plant fiber is derived can be depithed such that the pith cell content of the stalk is less than about 1% by weight. Notably, the presence of pith cells in the plant-based fibrous composition can result in decreased freeness of the plant-based fibrous composition.

The stalk can comprise alpha cellulose, lignin, and/or hemicellulose. The alpha cellulose content of the stalk can be from about 20% to about 80% by weight, such as greater than about 20% by weight, such as greater than about 30% by weight, such as greater than about 40% by weight, such as greater than about 50% by weight, such as greater than about 60% by weight, such as greater than about 70% by weight. Generally, the alpha cellulose content of the stalk is less than about 80% by weight, such as less than about 70% by weight, such as less than about 60% by weight, such as less than about 50% by weight, such as less than about 40% by weight, such as less than about 30% by weight.

In one aspect, the lignin content of the stalk can be from about 1% to about 30% by weight, such as greater than about 1% by weight, such as greater than about 5% by weight, such as greater than about 10% by weight, such as greater than about 15% by weight, such as greater than about 20% by weight, such as greater than about 25% by weight. In general, the lignin content of the stalk is less than about 30% by weight, such as less than about 25% by weight, such as less than about 20% by weight, such as less than about 15% by weight, such as less than about 10% by weight, such as less than about 5% by weight.

Further, in another aspect, the hemicellulose content of the stalk is from about 20% to about 40% by weight, such as greater than about 20% by weight, such as greater than about 25% by weight, such as greater than about 30% by weight, such as greater than about 35% by weight. In general, the hemicellulose content of the stalk is less than about 40% by weight, such as less than about 35% by weight, such as less than about 30% by weight, such as less than about 25% by weight.

In one aspect, the stalk can be chemically refined so that the first plant fiber is derived from chemically refined stalk. For instance, the stalk can be cooked in a tank, such as a hydrapulper, in a liquid medium, such as a solution of sodium hydroxide and water. The introduction of the stalk into the solution of sodium hydroxide and water can yield a chemically refined stalk. The sodium hydroxide content of this solution can be from about 5% to about 25% by weight, such as greater than about 5% by weight, such as greater than about 8% by weight, such as greater than about 10% by weight, such as greater than about 12% by weight, such as greater than about 14% by weight, such as in an amount greater than about 16% by weight. Generally, the sodium hydroxide content of the solution is less than about 25% by weight, such as less than about 16% by weight, such as less than about 14% by weight, such as less than about 12% by weight, such as less than about 10% by weight, such as less than about 8% by weight.

Generally, the plant-based fibrous composition of the present disclosure can have enhanced physical and mechanical properties. The physical and mechanical properties of the plant-based fibrous composition were determined by forming hand sheets according to TAPPI T205. Various mechanical properties of the plant-based fibrous composition use the basis weight of the plant-based fibrous composition in the numerical expression of the respective mechanical property. The mass per unit area is referred to as basis weight. As used herein, the basis weight is measured according to TAPPI T410. In one aspect, the plant-based fibrous composition can have a basis weight from about 50 gsm to about 1000 gsm, such as from about 200 gsm to about 800 gsm, such as from about 400 gsm to about 700 gsm.

The resistance of the plant-based fibrous composition to tearing divided by the basis weight of the composition is referred to as the tear index. As used herein, tear index is measured according to TAPPI T414. In one aspect, the plant-based fibrous composition can have a tear index from about 3 mN m²/g to about 6 mN m²/g, such as greater than about 3 mN m²/g, such as greater than about 3.5 mN m²/g, such as greater than about 4.0 mN m²/g, such as greater than about 4.5 mN m²/g, such as greater than about 5.0 mN m²/g, such as greater than about 5.5 mN m²/g. The plant-based fibrous composition generally has a tear index less than about 6.0 mN m²/g, such as less than about 5.5 mN m²/g, such as less than about 5.0 mN m²/g, such as less than about 4.5 mN m²/g, such as less than about 4.0 mN m²/g, such as less than about 3.5 mN m²/g.

The rate at which a dilute suspension of the plant-based fibrous composition drains water is referred to as the freeness. As used herein, freeness is measured according to TAPPI T227. The freeness can be a measure of the amount of refinement of the plant-based fibrous composition. In one aspect, the plant-based fibrous composition can have a freeness from about 250 mICSF to about 750 mICSF, such as greater than about 250 mICSF, such as greater than about 300 mICSF, such as greater than about 350 mICSF, such as greater than about 400 mICSF, such as greater than about 450 mICSF, such as greater than about 500 mICSF, such as greater than about 550 mICSF, such as greater than about 600 mICSF, such as greater than about 650 mICSF, such as greater than about 700 mICSF. Generally, the plant-based fibrous composition has a freeness less than about 750 mICSF, such as less than about 700 mICSF, such as less than about 650 mICSF, such as less than about 600 mICSF, such as less than about 550 mICSF, such as less than about 500 mICSF, such as less than about 450 mICSF, such as less than about 400 mICSF, such as less than about 350 mICSF, such as less than about 300 mICSF.

The maximum tensile force developed in the plant-based fibrous composition before rupture divided by the basis weight of the composition is referred to as tensile index. As used herein, tensile index is measured according to TAPPI T494. In one aspect, the plant-based fibrous composition can have a tensile index from about 10 N m/g to about 60 N m/g, such as greater than about 10 N m/g, such as greater than about 20 N m/g, such as greater than about 30 N m/g, such as greater than about 40 N m/g, such as greater than about 50 N m/g. The plant-based fibrous composition generally has a tensile index less than about 60 N m/g, such as less than about 50 N m/g, such as less than about 40 N m/g, such as less than about 30 N m/g, such as less than about 20 N m/g.

The maximum pressure required to rupture the plant-based fibrous composition divided by the basis weight of the composition is referred to as the burst index. As used herein, burst index is measured according to TAPPI T403. The plant-based fibrous composition can have a burst index from about 0.3 kPa m²/g to about 3.3 kPa m²/g, such as greater than about 0.3 kPa m²/g, such as greater than about 0.8 kPa m²/g, such as greater than about 1.3 kPa m²/g, such as greater than about 1.8 kPa m²/g, such as greater than about 2.3 kPa m²/g, such as greater than about 2.8 kPa m²/g. The plant-based fibrous composition generally has a burst index less than about 3.3 kPa m²/g, such as less than about 2.8 kPa m²/g, such as less than about 2.3 kPa m²/g, such as less than about 1.8 kPa m²/g, such as less than about 1.3 kPa m²/g, such as less than about 0.8 kPa m²/g.

The amount of work required to rupture the plant-based fibrous composition under tensile force is referred to as tensile energy absorption. As used herein, tensile energy absorption is measured according to TAPPI T494. In one aspect, the plant-based fibrous composition can have a tensile energy absorption from about 2 J/m² to about 60 J/m², such as greater than about 2 J/m², such as greater than about 10 J/m², such as greater than about 20 J/m², such as greater than about 30 J/m², such as greater than about 40 J/m², such as greater than about 50 J/m². Generally, the plant-based fibrous composition has a tensile energy absorption less than about 60 J/m², such as less than about 50 J/m², such as less than about 40 J/m², such as less than about 30 J/m², such as less than about 20 J/m², such as less than about 10 J/m^{2.}

The relation of the volume of the plant-based fibrous composition to the weight of the plant-based fibrous composition is referred to as bulk. The reciprocal of density can be referred to as bulk. In one aspect, the plant-based fibrous composition can have a bulk from about 1.5 cm³/g to about 3.5 cm³/g, such as greater than about 1.5 cm³/g, such as greater than about 2.0 cm³/g, such as greater than about 2.5 cm³/g, such as greater than about 3.0 cm³/g. In general, the plant-based fibrous composition has a bulk less than about 3.5 cm³/g, such as less than about 3.0 cm³/g, such as less than about 2.5 cm³/g, such as less than about 2.0 cm³/g.

Generally, the plant-based fibrous composition can comprise plant fiber from one or more plants. For instance, the plant-based fibrous composition can comprise a first plant fiber and a second plant fiber, one plant providing the first plant fiber and a second plant providing the second plant fiber. The first plant fiber and the second plant fiber can be derived from different plants. The second plant fiber can be selectively chosen to enhance the various physical and mechanical properties of the plant-based fibrous composition. In one aspect, the second plant fiber is a non-wood fiber, such as fiber derived from a secondary plant.

The second plant fiber can be derived from the stalk of the second plant. The stalk of which the second plant fiber is derived can be particularly well suited for chemical refinement separately or in combination with the stalk of which the first plant fiber is derived. In one aspect, the second plant fiber can comprise bast fiber such as flax fiber, hemp fiber, kenaf fiber, ramie fiber, jute fiber, or a combination thereof.

In one aspect, the first plant fiber can have an average fiber length that is shorter than the average fiber length of the second plant fiber. In general, the fibers of the second plant fiber can have an average fiber length from about 1.75 mm to about 2.5 mm, such as greater than about 1.75 mm, such as greater than about 1.85 mm, such as greater than about 1.95 mm, such as greater than about 2.0 mm, such as greater than about 2.15 mm, such as greater than about 2.25 mm, such as greater than about 2.35 mm, such as greater than about 2.45 mm.

In one aspect, the first plant fiber and the second plant fiber can be combined together and refined together. Alternatively, each fiber can be refined separately. In still another embodiment, each fiber can be refined separately, combined together, and then refined a further amount. In one aspect, the first plant fiber can be refined to a smaller degree than the second plant fiber. In still another aspect, the first plant fiber not only has a shorter average fiber length but is refined less than the second plant fiber. In yet another aspect, the first plant fiber not only has a shorter average fiber length but is refined more than the second plant fiber.

Generally, the plant-based fibrous composition of the present disclosure can comprise one or more binders. A binder can help increase integrity and increase strength. The binder, for instance, can comprise any suitable natural polymer obtained directly or derived from natural ingredients, such as plants. The binder, for instance, can be a starch, a starch derivative, a cellulose derivative, cellulose nanofibers, cellulose nanocrystals, alginate, guar gum, lignin, natural rubber, polylactic acid, a polysaccharide, or mixtures thereof. In one aspect the binder comprises a polysaccharide such as pullulan, pectin, chitosan, carrageenan, or mixtures thereof. Cellulose derivatives that can be incorporated into the plant-based fibrous composition include carboxymethyl cellulose, hydroxypropyl methylcellulose, morpholinothiosemicarbazide-modified cellulose, ethyl cellulose, and the like. If present, one or more binders can be incorporated into the plant-based fibrous composition in an amount less than about 3% by weight, such as in an amount less than about 2.5% by weight, such as in an amount less than about 2% by weight, such as in an amount less than about 1.5% by weight, such as in an amount less than about 1.0% by weight, such as in an amount less than about 0.5% by weight. One or more binders can be present in the plant-based fibrous composition generally in an amount greater than about 0.05% by weight, such as in an amount greater than about 0.1% by weight.

In general, the plant-based fibrous composition can also comprise one or more enzymes. An enzyme can help increase the integrity, fibrillation, and strength of the plant-based fibrous composition. The enzyme, for instance, can be xylanase, lipase, laccase, mannanases, peroxidases, or mixtures thereof.

The fibrous product of the present disclosure is well suited for use in many and diverse applications. Indeed, the fibrous product as disclosed herein can be thermoformed into any number of products. In one aspect the fibrous product can be a 3-D or 3-dimensional product. For instance, the fibrous product can be thermoformed into food packaging, automotive parts, and electronics packaging. The fibrous product can be particularly well-suited for use in applications favoring biodegradability, compostability, or recyclability. The biodegradability, compostability, and recyclability of the fibrous product can be achieved without hindering the mechanical properties of the fibrous product.

The present disclosure is also directed to a process for producing a fibrous product. The process for producing the fibrous product can include a chemical pulping process, a mechanical pulping process, or a combination thereof. Notably, the present inventors have discovered that the chemical pulp processing of canola fiber can result in fibrous products with enhanced physical and mechanical properties.

The chemical pulping process can include introducing a first plant fiber in a tank containing a liquid medium. The liquid medium can comprise sodium hydroxide. Thereafter, the first plant fiber can be cooked in the liquid medium. The first plant fiber can be cooked under atmospheric conditions. The first plant fiber can then be subjected to a first washing. The first washing can increase the solids content of the first plant fiber to about 15% to about 45% by weight. The process can further include a first refining of the first plant fiber. Next, the first plant fiber can be screened. Afterward, the first plant fiber can be subjected to a second washing. Then, the first plant fiber can be subjected to a second refining.

Further, the process can include thermoforming a plant-based fibrous composition into a variety of products. The plant-based fibrous composition can be used in a pressure forming process by heating the plant-based fibrous composition to a certain temperature so that it becomes flowable. Positive pressure can then be applied above the heated fibrous product. The positive pressure can press the material onto the surface of a mold to create a 3-dimensional article.

The sodium hydroxide as disclosed above can be present in the liquid medium in an amount from about 5% to about 25% by weight, such as in an amount greater than about 5% by weight, such as in an amount greater than about 8% by weight, such as in an amount greater than about 10% by weight, such as in an amount greater than about 12% by weight, such as in an amount greater than about 14% by weight, such as in an amount greater than about 16% by weight. In general, the sodium hydroxide content of the liquid medium is in an amount less than about 25% by weight, such as in an amount less than about 16% by weight, such as in an amount less than about 14% by weight, such as in an amount less than about 12% by weight, such as in an amount less than about 10% by weight, such as in an amount less than about 8% by weight.

As disclosed herein, the cooking step of the process can occur at a temperature from about 95° C. to about 98° C. The temperature of the liquid medium can be maintained by direct steaming.

After the cooking step of the process, the first washing step of the process can involve introducing the first plant fiber to a wash screw press. In one aspect, the first washing can increase the solids content of the first plant fiber to about 15% to about 45% by weight, such as greater than about 15% by weight, such as greater than about 20% by weight, such as greater than about 25% by weight, such as greater than about 30% by weight, such as greater than about 35% by weight. Generally, the solids content of the first plant fiber after the first washing is less than about 45% by weight, such as less than about 40% by weight, such as less than about 35% by weight, such as less than about 30% by weight, such as less than about 25% by weight, such as less than about 20% by weight.

As disclosed herein, the first refining step of the process can include, in addition to the refining methods previously disclosed herein, pumping the first plant fiber through a low-consistency disc refiner into a refined pulp tank. Thereafter, the first plant fiber can be screened through a pressure screen. The screening step of the process can remove contaminants and can fractionate the first plant fiber by fiber length.

The first plant fiber screen accepts can then be subjected to a second washing. The second washing can include one or more washing stages using screw presses. In one aspect, the second washing can comprise three washing stages using screw presses. Each washing stage can thicken the first plant fiber from a consistency of about 4% to about 30%. In one aspect, the second washing of the first plant fiber can increase the freeness of the first plant fiber by about 150% to about 400% compared to the freeness of the first plant fiber after the screening step of the first plant fiber.

The first plant fiber can also be subjected to a second refining. The second refining can occur in a low-consistency disc refiner.

As previously disclosed, the present disclosure is also directed to a process for producing a fibrous product, the process including a mechanical pulping process. In one aspect, the mechanical pulping process can involve the use of no chemicals. In another aspect, the mechanical pulping process can involve the use of chemicals to improve processing. The mechanical pulping process can include introducing the first plant fiber into an extruder at a consistency from about 20% to about 40%, such as about 30%. The extruder can be a twin-screw extruder. Next, the first plant fiber can be extruded in the extruder at a temperature of about 90° C. to about 95° C. for a period of about 50 minutes to about 70 minutes. Thereafter, the first plant fiber can be refined. Afterward, the first plant fiber can be washed.

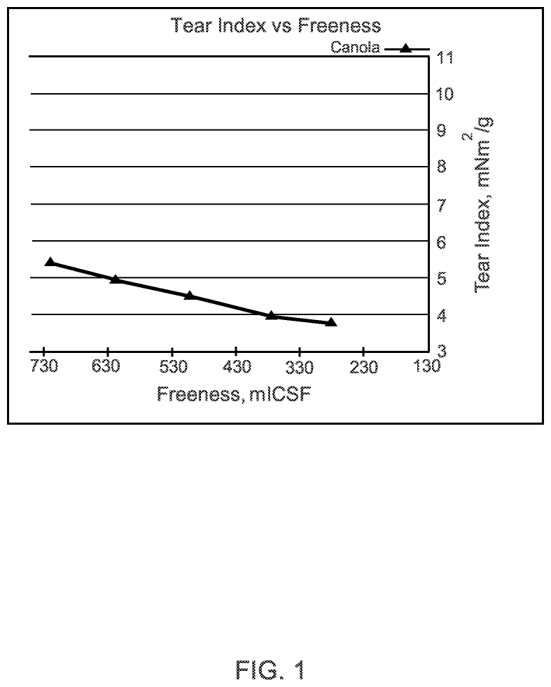

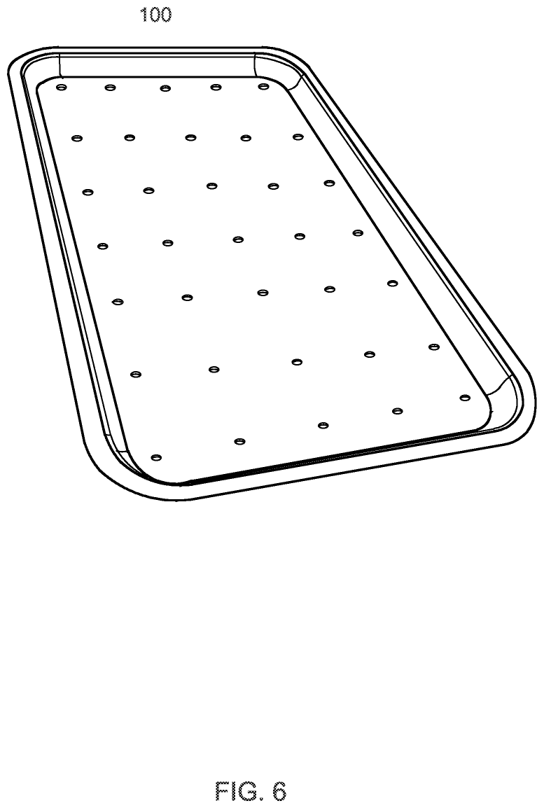

Referring to FIG. 6, food packaging 100 is illustrated. The food packaging 100 can be made in accordance with the present disclosure. The food packaging 100, for instance, can be made by pressure forming as disclosed herein. In addition to the food packaging 100 as disclosed in FIG. 1, the fibrous product of the present disclosure can be many different types of packaging, including other food packaging articles and electronics packaging.

The present disclosure may be better understood with reference to the following example.

### Example 1

A plant-based fibrous composition was made according to the following method. Canola stalks were cooked with an Adirondack Formax 100H high consistency pulper. The pulping conditions are presented in Table 1:

TABLE 1

| Equipment | Pulper |
|---|---|
| Manufacturer | Adirondack |
| Model | Formax 100H |
| Canola Stalk [kg] | 0.8-1.0 |
| Consistency [%] | 10 |
| Time [min] | 60 |
| Temperature [° C.] | 95 |
| Sodium hydroxide [%] | 10 |

After the cooking step, the refined stalk was washed in a centrifuge to bring it to a consistency of about 35%. The refined stalk was then screened using a 0.012 inch screen. The screen rejects were subjected to PFI mill refining using 1500 revolutions. Thereafter, the screen rejects were combined with the screen accepts. Fresh water was used to flush the pulp through the screen and the accepts were centrifuged to remove excess water. The combined pulp was then refined using a Valley beater to obtain pulp with a freeness from about 300 mICSF to about 500 mICSF.

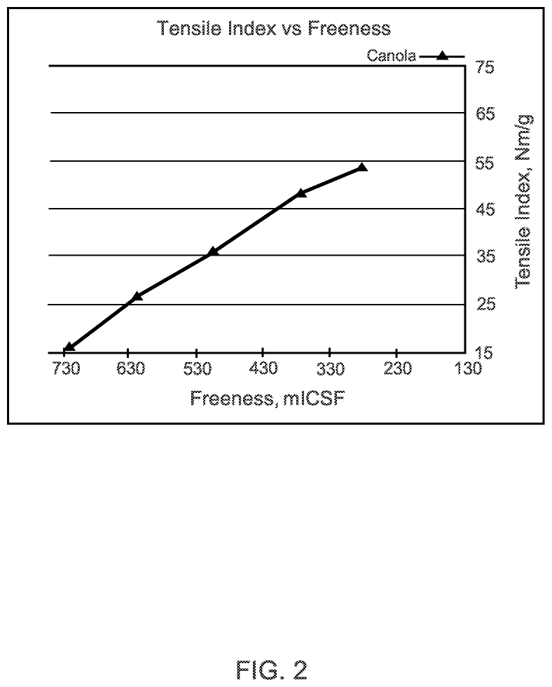

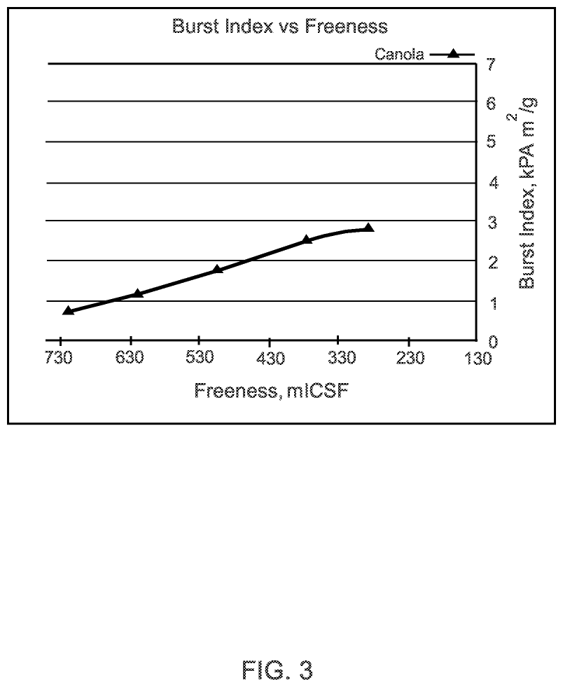

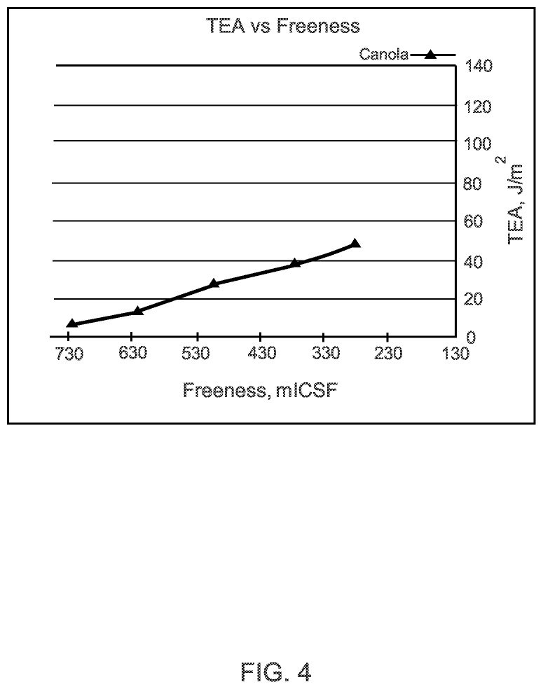

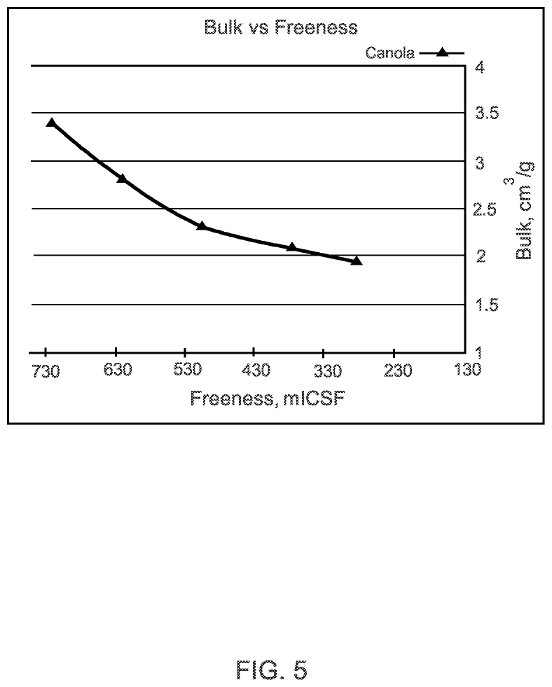

The Valley beater was utilized to develop a 5-point beater curve as observed in FIG. 1-FIG. 5. Further, other physical and mechanical properties were determined and recorded in FIG. 1-FIG. 5 in accordance with the standards as previously disclosed herein. FIG. 1 is a graph of the Tear Index vs. Freeness. FIG. 2 is a graph of the Tensile Index vs. Freeness. FIG. 3 is a graph of the Burst Index vs. Freeness. FIG. 4 is a graph of the TEA vs. Freeness. FIG. 5 is a graph of the Bulk vs. Freeness.

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the present disclosure so further described in such appended claims.

What is claimed:

1. A fibrous product for forming thermoformed articles comprising:
a plant-based fibrous composition comprising a first plant fiber,
wherein the first plant fiber is a non-wood fiber, wherein the first plant fiber has an average fiber length less than about 0.75 mm; and
the plant-based fibrous composition further comprising a binder, wherein the binder is a natural polymer; wherein the binder is present in the plant-based fibrous composition in an amount less than that about 3% by weight.

2. The fibrous product of claim 1, wherein the first plant fiber comprises secondary plant fibers.

3. The fibrous product of claim 1, wherein the first plant fiber comprises canola fibers.

4. The fibrous product of claim 1, wherein the first plant fiber is derived from chemically refined stalk.

5. The fibrous product of claim 1, wherein the plant-based fibrous composition has a basis weight from about 50 gsm to about 1000 gsm.

6. The fibrous product of claim 1, wherein the plant-based fibrous composition has a tear index from about 3 mN m²/g to about 6 mN m²/g.

7. The fibrous product of claim 1, wherein the plant-based fibrous composition has a freeness from about 250 mICSF to about 750 mICSF.

8. The fibrous product of claim 1, wherein the plant-based fibrous composition has a tensile index from about 10 N m/g to about 60 N m/g.

9. The fibrous product of claim 1, wherein the plant-based fibrous composition has a burst index from about 0.3 kPa m²/g to about 3.3 kPa m²/g.

10. The fibrous product of claim 1, wherein the plant-based fibrous composition has a tensile energy absorption from about 2 J/m² to about 60 J/m^{2.}

11. The fibrous product of claim 1, wherein the plant-based fibrous composition has a bulk from about 1.5 cm³/g to about 3.5 cm³/g.

12. The fibrous product of claim 1, wherein the first plant fiber has a diameter from about 5 μm to about 50 μm.

13. The fibrous product of claim 1, wherein the plant-based fibrous composition further comprises a second plant fiber.

14. The fibrous product of claim 13, wherein the second plant fiber comprises flax fiber, hemp fiber, kenaf fiber, ramie fiber, jute fiber, or a combination thereof.

15. The fibrous product of claim 13, wherein the first plant fiber has an average fiber length that is shorter than the average fiber length of the second plant fiber.

16. The fibrous product of claim 1, wherein the natural polymer comprises any one of a starch, a starch derivative, a cellulose derivative, alginate, guar gum, a polysaccharide, lignin, natural rubber, polylactic acid, or mixtures thereof.

17. The fibrous product of claim 1, wherein the fibrous product is 3-dimensional.

18. A process for producing a fibrous product comprising:
introducing a first plant fiber in a tank containing a liquid medium, wherein the liquid medium comprises sodium hydroxide;
cooking the first plant fiber, wherein the cooking occurs under atmospheric conditions;
a first washing of the first plant fiber, wherein the first washing increases the solids content of the first plant fiber to a range from about 15% to about 45%;
a first refining the first plant fiber;
screening the first plant fiber; and
a second washing of the first plant fiber.

19. The process of claim 18, wherein the first plant fiber is a non-wood fiber.

20. The process of claim 19, wherein the non-wood fiber is canola fiber.

21. The process of claim 18, wherein the second washing of the first plant fiber can increase the freeness of the first plant fiber by about 150% to about 400% when compared to the freeness of the first plant fiber after the screening of the first plant fiber.
